(19) United States
(12) Patent Application Publication
(10) Pub. No.: US 2005/0111093 A1
(43) Pub. Date: May 26, 2005

(54) Shielded-ergonomic microscope stages

(75) Inventors: Russell Bonaventura, Williamsville, NY (US); Scott Parks, East Amherst, NY (US); Manfred Gilbert, Schoeffengrund (DE)

Correspondence Address: SIMPSON & SIMPSON, PLLC, 5555 Main Street, Williamsville, NY, 14221, US

(73) Assignee: Leica Microsystems Wetzlar GmbH, Wetzlar (DE)

(21) Appl. No.: 10/810,979

(22) Filed: Mar. 26, 2004

Related U.S. Application Data
(63) Continuation-in-part of application No. 10/721,695, filed on Nov. 25, 2003.
(63) Continuation-in-part of application No. 10/733,628, filed on Dec. 11, 2003.

(51) Int. Cl. G02B 21/00

(52) U.S. Cl. 359/391; 359/393

(57) ABSTRACT

Advanced microscope stages are shielded from dust and debris collecting on components by placing all or virtually all stage components below the stage floor. The shielded stages comprise a stage having a top side and a bottom side, an opening in the stage floor in the form of a linear slot, a carriage positioned adjacent to the slot for movement in a direction generally parallel with the slot, drive means for the carriage and stage, specimen retaining means on the top side of the stage, and means for affixing the specimen retaining means to the carriage through the opening in the stage floor. The advanced microscope stages may also have more ergonomic structural features with rounded rims and corners for greater user comfort.

### CROSS REFERENCE TO RELATED APPLICATIONS

This application for patent is a Continuation-in-Part of U.S. patent application Ser. No. 10/721,695, filed Nov. 25, 2003 and Ser. No. 10/733,628 filed Dec. 11, 2003.

### FIELD OF THE INVENTION

The present invention relates generally to microscopy, and more specifically, to microscope stages adapted for improved ergonomics and shielding from dust and debris.

### BACKGROUND OF THE INVENTION

As is well known, a microscope is an optical instrument used to view, examine and study very small objects. There are many different types of microscopes, each best suited to particular applications. These include compound microscopes, stereomicroscopes, confocal microscopes, inverted microscopes, and laser microscopes, to name but a few.

The present invention relates generally to compound microscopes and to those microscopes that are equipped with sample stages capable of being controlled by stage drive mechanisms.

Microscopes have long used stages for the positioning of samples within the optical path. An object can be manipulated by moving the stage forwards and backwards, left and right, and up and down. A common convention for naming the left-right, front-back, and up-down axes is x, y, and z, respectively.

Often, the focusing mechanism functions by adjusting the stage height. By changing the sample height, the microscopist can observe different depths within the z-axis of the sample.

In order to adjust the x or the y position, the user must have available a stage control mechanism capable of performing these movements. While some stage positioning components have been placed under the microscope stage, the ever increasing complexity and sophistication of microscopes has impeded optimum shielding of key components for microscope stage management from exposure to dust and debris and their accumulation on such components. Consequently, microscope stage components can require regular cleaning, which can be both tedious and time consuming.

Often, microscopists find it more convenient to manipulate the microscope stage for positioning the specimen slide without restrictions imposed by a stage drive system. A large percentage of pathologists, for example, prefer to use a “hand-drive” technique, i.e., rapid movement of the specimen by manually moving the slide mount, and by-passing the mechanical stage drive system. However, current stages are not adapted for convenient and comfortable engagement of the slide mount by hand for manual adjustments over extended time periods. Current microscope stages have rather sharp 90° edges and contact points, all of which can irritate and even abrade the skin with continuous contact, causing discomfort to users.

Accordingly, it would be highly desirable to have a more ergonomic microscope stage adapted for more convenience and comfort for the user during hand-drive operation, also comprising improved microscope stage assemblies, and microscopes so equipped, wherein virtually all components of the stage are more effectively shielded from dust, debris, specimen residue, etc., as to require less frequent cleaning and related maintenance procedures.

### SUMMARY OF THE INVENTION

It is therefore one principal object of the invention to provide for a microscope stage assembly wherein all or practically all components are positioned on the bottom side of the stage so they are more effectively shielded from dust and debris accumulating in key parts of the assembly, while simultaneously allowing full movement of the specimen and stage in x, y and/or z axes. This is accomplished principally by means of a slot in the stage enabling the specimen retainer to be connected to the drive assembly directly through the floor of the microscope stage where it engages with a drive system. Preferably, the specimen retainer is also of sufficient width to overlap and cover substantially the entire width of the slot in the stage floor further shielding components of the drive system from dust and debris.

Accordingly, one object of the invention is to provide for a microscope stage assembly comprising a stage having a top side, a bottom side, and an opening in the stage, preferably in the form of a linear slot. A carriage is positioned adjacent to the slot for movement in a direction generally parallel with the slot. Drive means for the carriage are included. The specimen retaining means is on the top side of the stage. The stage assembly includes further means, such as connecting pins for affixing the specimen retaining means to the carriage through the slot/opening in the stage. Typically, movement of the carriage will result in lateral movement of the specimen retaining means, and concomitantly the specimen slide, adjusting the position of the specimen within the optical path along the x-axis, i.e., so the specimen slide moves laterally, to the right or to the left relative to the floor of the stage.

It is yet a further object of the invention to provide a microscope stage assembly preferably comprising a stage mounting plate on the bottom-side of the stage as means for affixing the stage assembly to a microscope. Accordingly, the microscope stage assembly also includes means for translation of the stage backwardly and forwardly along the y-axis relative to the stationary mounting plate. One embodiment for performing this operation is by means of a microscope stage drive mechanism engaging a rack affixed to the stage mounting plate for movement of the stage along the y-axis relative to the mounting plate when affixed to a microscope. That is, the microscope stage drive mechanism and the rack are operatively arranged for movement of the stage relative to the mounting plate and microscope for forward-backward movement of the stage along the y-axis.

It is also a further object of the invention to provide a drive system for the microscope stage assembly of the invention, such as a drive belt and pulley assembly, for the moving the carriage and specimen retaining means laterally, right and left. The drive system for the carriage is positioned on the bottom side of the stage shielding it from dust, debris, and the like. This includes a microscope stage drive mechanism for movement of the carriage and specimen retaining means along the x-axis, and also, for movement of the stage per se along the y-axis.

Although not a requirement, a particularly preferred stage drive mechanism is an interchangeable microscope stage drive, for direct hand engagement for actuation of the drive system for adjusting the specimen slide in the optical path in both the x and y axes. This ergonomic stage drive can be detachably employed on either the right or left bottom-side of the microscope stage, depending on the needs of a particular user, and especially where a microscope is shared by multiple users. Typically, within this group of users are found those that favor either the right or left hand for positioning of the specimen slid on the stage. Accordingly, the interchangeable stage drive mechanism possesses the convertibility feature for ergonomically accommodating both right and left handed users. Hence, the stage of the microscope stage assembly of this invention also comprises a first engagement means for detachably securing a microscope stage drive mechanism at a first location on the stage, and a second engagement means for detachably connecting the microscope stage drive mechanism at a second location on the stage.

This interchangeable microscope stage drive mechanism suitable for detachably securing to the bottom side of a microscope stage at more than one location of the stage is described in detail in a copending US application entitled “Interchangeable Microscope Stage Drive Assembly”, filed on even date herewith, the application being incorporated-by-reference herein.

It is still a further object of the invention to provide the foregoing microscope stage assembly featuring a stage configuration wherein the peripheral edge(s) of the stage comprises a rim, and more particularly, a rim that is rounded, including corners of the stage that are sufficiently rounded to avoid pressure points. The rounded rim, according to this aspect of the invention, renders a microscope so equipped more ergonomic, especially for the user who employs the “hand-drive” technique, by the elimination of sharp contact points on at least one edge, i.e., one or more edges of a microscope stage.

It is to be understood, this latter feature of a stage having at least one edge having a rim which eliminates at least one sharp contact point is applicable to virtually any microscope stage, regardless of the features of the stage assembly.

These and other objects, features and advantages of the present invention will become readily apparent to those having ordinary skill in the art upon reading of the following detailed description in view of the drawings and appended claims.

### BRIEF DESCRIPTION OF THE DRAWINGS

The nature and mode of operation of the present invention will now be more fully described in the following detailed description of the invention taken with the accompanying drawing figures, in which:

FIG. 1 is a perspective view of a typical compound microscope configured for use with the shielded-ergonomic microscope of the present invention;

FIG. 2 is a perspective view of the shielded microscope stage drive assembly of the present invention alone;

FIG. 3 is a perspective view of the shielded-ergonomic microscope stage of FIG. 2 with the slide mount removed to better illustrate the stage floor;

FIG. 4 is a perspective view of the bottom of the shielded microscope stage assembly of the present invention with an interchangeable microscope stage drive mechanism operatively arranged for right-handed use;

FIG. 5 is a perspective view of the bottom of the shielded microscope stage assembly of the present invention with an interchangeable microscope stage drive mechanism operatively arranged for left-handed use;

FIG. 6 is a further view of the bottom of the shielded-ergonomic microscope stage of the present invention, including means for engaging the interchangeable microscope stage drive mechanism in the right-handed operative arrangement;

FIG. 7 is a perspective view of the bottom of the shielded-ergonomic microscope stage of the present invention, including removal of the interchangeable microscope stage drive mechanism from an operative arrangement;

FIG. 8 is a further bottom view of the shielded-ergonomic microscope stage of the present invention, including means for engaging the interchangeable drive mechanism in the left-handed operative arrangement;

FIG. 9 is a top view of the shielded-ergonomic microscope stage of the present invention with the slide mount off center to illustrate the through slot in the stage floor;

FIG. 10 is a cross-sectional, upside down view of the shielded-ergonomic microscope stage assembly of the present invention taken generally along line 10-10 of FIG. 9;

FIG. 11 is a perspective view of the ergonomically modified microscope stage with rounded peripheral edges and corners for greater user comfort and safety, and

FIG. 12 is a sectional view of the microscope stage of the present invention taken generally along line 12-12 of FIG. 11.

### DETAILED DESCRIPTION OF THE INVENTION

It should be appreciated at the outset that while the present invention relates to an “Shielded-Ergonomic Microscope Stages”, the Assignees of the present application for patent have developed certain other improvements to microscopes described in United States patent applications entitled “Interchangeable Microscope Stage Drive Assembly”, “Releasable/Interchangeable Fine Focus Knob for a Microscope”, “Ergonomically Arranged Object Adjustment Controls”, “Lamp Assembly for a Microscope” and “Means for Transporting a Microscope”, which applications are filed concurrently herewith by the Assignees of the present application for patent, which applications are incorporated herewith by reference in their entireties.

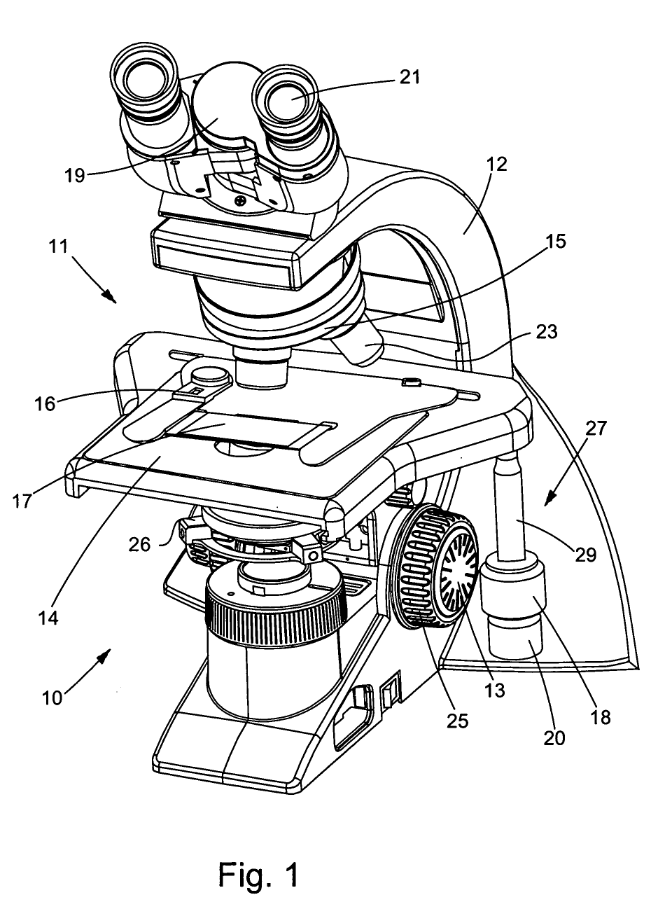

Additionally, it should be appreciated that like drawing numbers on different drawing views identify identical structural elements of the invention. While the present invention is described with respect to what is presently considered to be the preferred embodiments, it is understood that the invention as claimed is not limited to the disclosed embodiments. In the description below, the terms “up”, “down”, “forward”, “backward”, “left”, “right”, and their derivatives, should be interpreted from the perspective of one viewing the microscope shown in FIG. 1.

Generally, the present invention comprises a shielded-ergonomic microscope stage assembly, including drive means therefor. Although not a fundamental requirement of the invention, in the embodiment of FIG. 1, as well as the other figures, the stage has been adapted to receive an interchangeable stage drive mechanism which can be operatively arranged in multiple locations within the stage. A conventional compound microscope is shown in perspective view of FIG. 1 in combination with the microscope stage assembly. Although the invention is suitable for use with a variety of light microscopes, it is useful to review the basic microscope structure and function to appreciate the present invention.

FIG. 1 illustrates the general structure of compound microscope 10. The microscope broadly comprises mounting stand 12 to which all the component pieces of the microscope are mounted. In the embodiment shown, the viewing body 19 is binocular, comprising the body and two eyepieces 21. The viewing body is not particularly germane to the invention, which is suitable for use with a microscope configured with any type of viewing body (monocular, binocular, trinocular, video, etc.). Objective lenses 23 are mounted to rotatable turret 15. Microscope 10 further comprises the shielded-ergonomic microscope stage assembly 11 of the invention mounted to stand 12. The top side of microscope stage assembly 11 comprises a slide mount 16, stage 14 and a drive mechanism 27. Slide mount 16 is incorporated into microscope stage assembly 11 and engages slide 17 retaining the specimen on the slide for viewing. Coarse focus knob 25 and fine focus knob 13 are mounted for rotation to stand 12. Rotating knobs 13 and 25 move stage 14 up and down, further moving slide 17 within the optical path of the microscope, allowing for focus at the specimen.

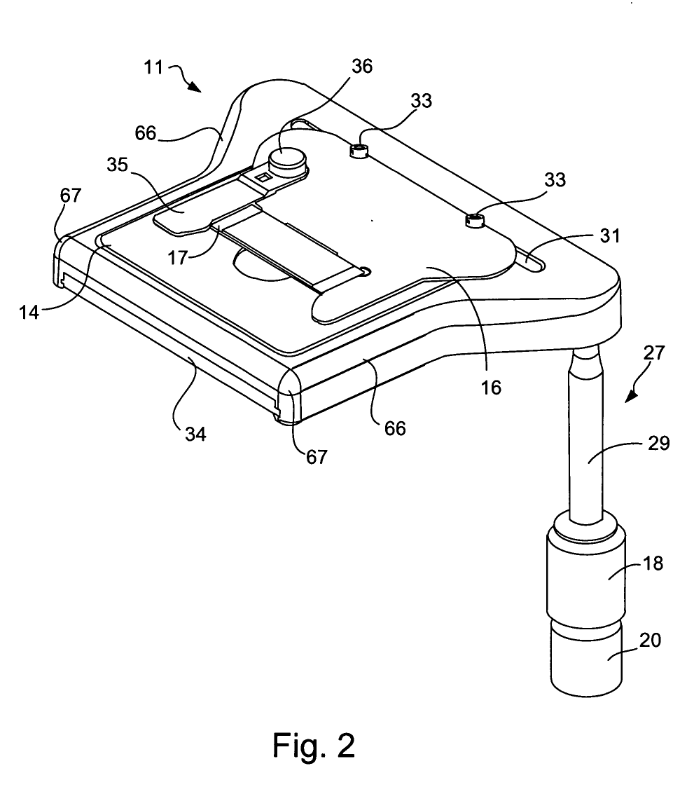

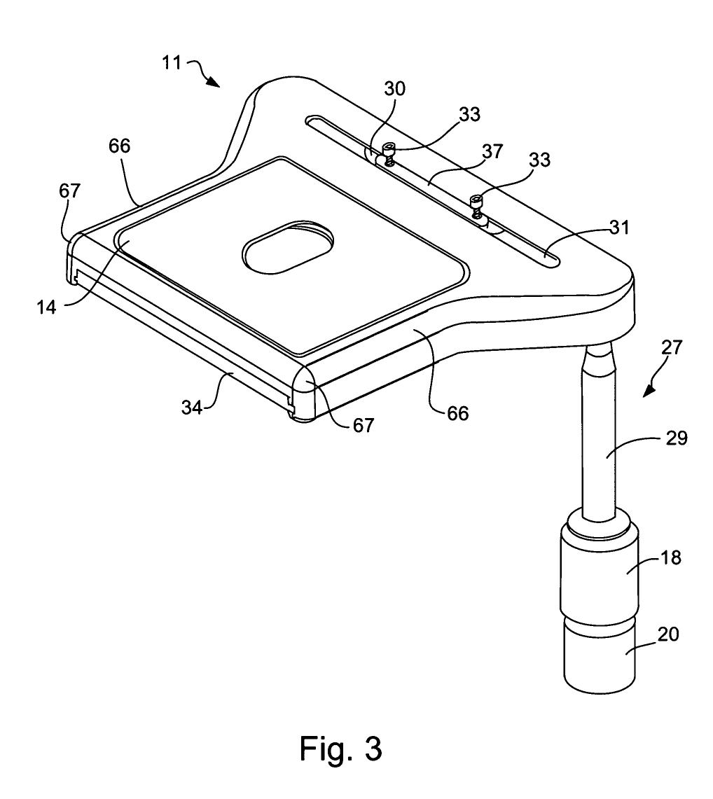

FIG. 2 is a perspective view of the microscope stage assembly 11 of the present invention removed from microscope 10 of FIG. 1. FIG. 3 is the same as FIG. 2, except slide mount 16 has been removed from stage 14. Stage 14 (FIG. 2) is shown supporting the detachable slide mount 16 equipped with a pivoting arm 35 affixed to the mount through a spring loaded lock nut 36. The pivoting arm 35 is thus biased to exert lateral compressive force against specimen slide 17 by engaging an edge of the slide, retaining it against a fixed adjacent cut-out region in mount 16.

The rear portion of stage 14 comprises a slot 31, in the form of a continuous linear shaped opening through the floor of the stage from the top side to the bottom side. A carriage 30 (FIG. 3) of the drive assembly moves parallel with the slot in the x-axis direction. Carriage 30 also comprises an elevation 37 (FIG. 3) of suitable dimension for entry and unimpeded slidable movement within slot 31. Elevation 37 is equipped with threaded holes for receiving locking pins 33 which engage with cutouts (not shown) in the rear edge of slide mount 16 for fastening the slide mount for lateral, right-left movement relative to stage 14. FIG. 3 illustrates the stage assembly with threaded pins loosened and slide mount 16 removed.

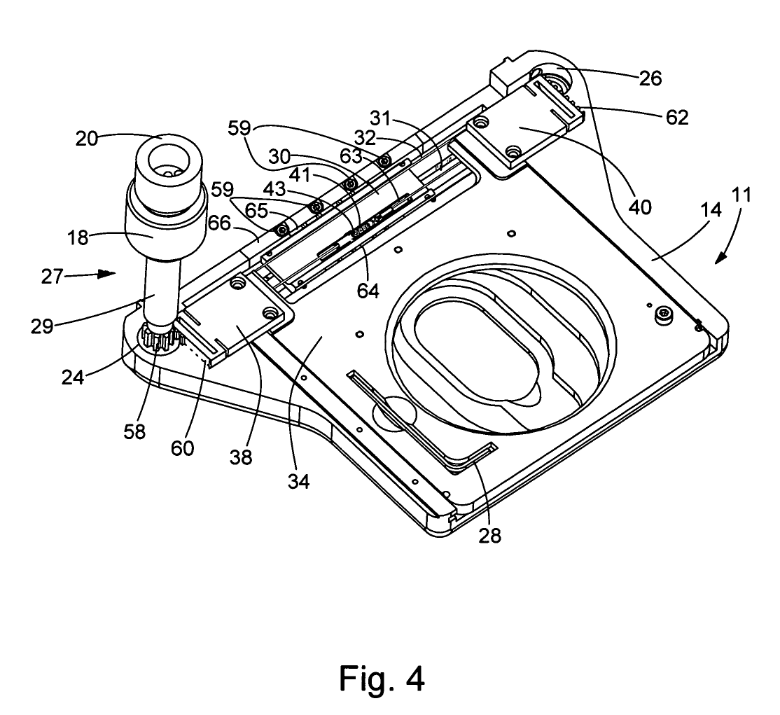

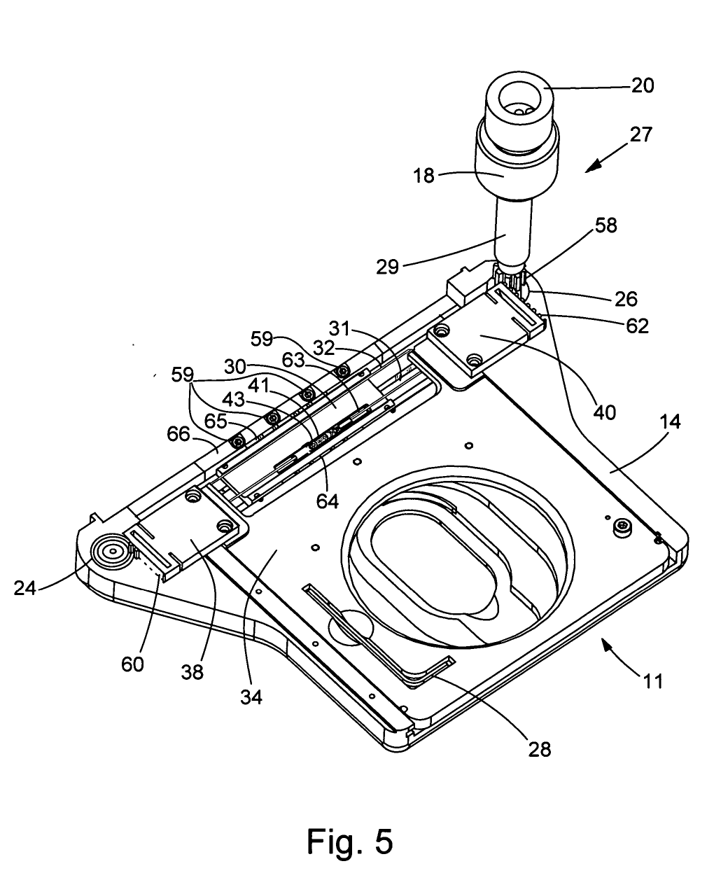

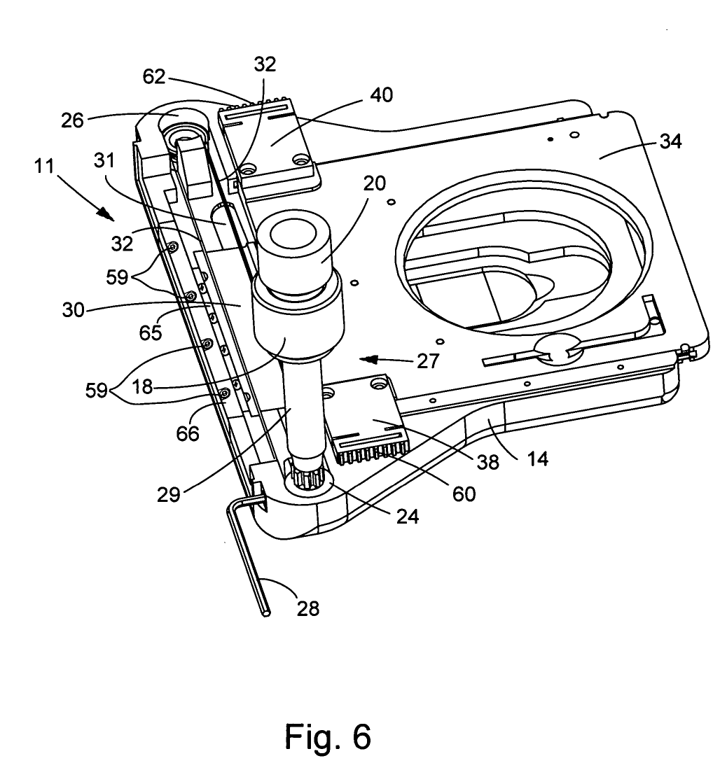

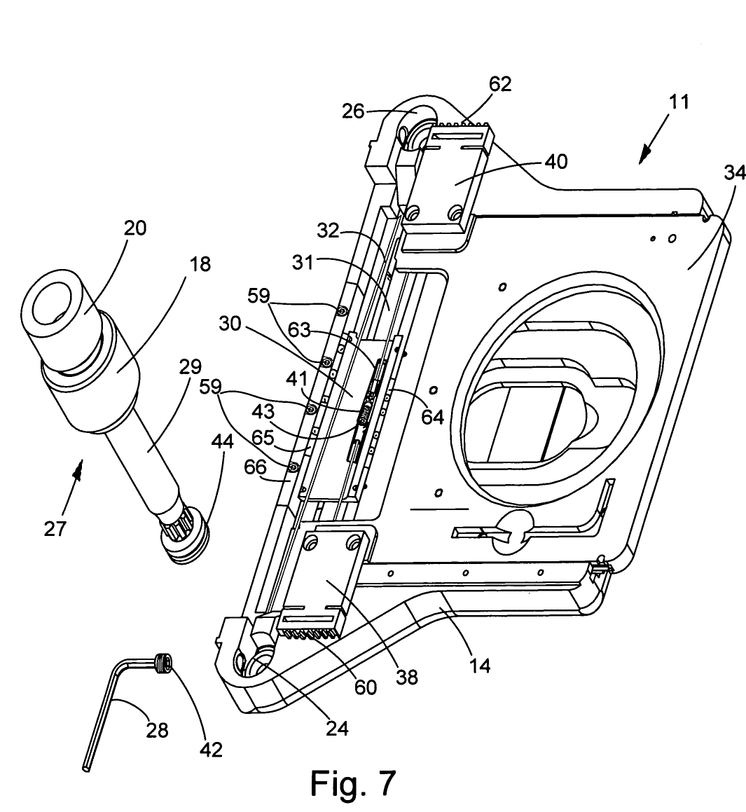

Drive 27 (FIGS. 2-8 and 10) is that of an interchangeable stage drive mechanism comprising drive shaft 29, first stage positioning knob 18 for movement of the stage along the y-axis, and second stage positioning knob 20 for movement of carriage 30 and mount 16 in the x-axis direction. Drive shaft 29 comprises outer drive shaft 22 (FIG. 10) and inner drive shaft 48. Drive 27 is arranged to be detachably secured to the underside of stage 14 (FIGS. 4-8 and 10) in a plurality of locations designated as mounting holes 24 and 26 to comfortably accommodate both right hand users (FIGS. 4 and 6) and left hand users (FIGS. 5 and 7). As previously discussed, the first stage positioning knob 18 is fixedly secured to drive outer drive shaft 22 to effect forward and backward movements of stage 14 relative to stage mounting plate 34. In this configuration, pinion 58 of drive 27 is located at the terminus of outer drive shaft 22, opposite first stage positioning knob 18. The teeth of pinion 58 engage teeth 60 of rack 38, the latter of which is rigidly mounted to stage mounting plate 34, causing forward and backward movement of stage 14 relative to mounting plate 34 when rotational force is applied by the operator to knob 18, causing pinion 58 to rotate.

FIGS. 4-8 illustrate details of the drive system for carriage 30 and slide mount 16 detachably fastened thereto for right and left movement of the mount. The drive system for lateral right-left movement of carriage 30 and mount 16 is positioned on the bottom-side of the stage affixed thereto through slot 30 of the stage floor for optimum shielding of the components from exposure to dust and debris. The drive system comprises a belt 32 in the form of a cable or equivalent structure strung about a pair of oppositely disposed drive pulleys 56 (FIG. 10) at side ends of the bottom of stage 14 positioned in mounting holes 24 and 26 on the bottom side of the stage. The plunger head 50 (FIG. 10) of the microscope stage drive mechanism 27 engages drive pulleys 56 when the microscope stage drive mechanism 27 is inserted into the right or left mounting holes 24-26, respectively.

Belt 32 also comprises a spring assembly 41 for maintaining belt 32 under continuous tension to avoid slippage when the pulleys are rotated. Spring assembly 41 is seated within a narrow groove 63 in the underside of carriage 30. Carriage 30 is mounted for parallel movement with slot 31 by means of bearing strips 64 and 65, of conventional design, each comprising a plurality of spaced roller bearings mounted on each side of the carriage. Carriage 30 and bearing strips 64-65 are mounted through the backside of stage 14 by removal of threaded pins 59 and retainer bar 66. Bearing strip 64 is first positioned in a bearing groove (not shown) between the sidewall of carriage 30 and an adjacent edge of the stage, followed by carriage 30; then bearing strip 65 adjacent to a bearing groove (not shown) in the sidewall of the carriage; and finally retainer bar 66 affixed to the underside of the stage by means of threaded pins 59.

Belt 32 may be affixed to carriage 30 through a pin 43 at spring assembly 41 assuring smooth, non-slip movement of carriage 30, elevation 37 in slot 31 and slide mount 16 when the drive assembly is actuated by rotation of second stage positioning knob 20 of drive 27. The bearing strips cooperate to maintain the carriage in a fixed path, allowing smooth reciprocating movements of carriage 30 and elevation 37 in slot 31 for adjusting the position of slide mount 16 and specimen slide 17 when the microscope stage drive mechanism is actuated by rotation of second stage positioning knob 20. As previously mentioned, second stage positioning knob 20 is fixedly secured to drive inner drive shaft 48 (FIG. 10) to effect left and right (x-axis) movement of slide mount 16 relative to stage 14, for adjusting the position of specimen slide 17 within the optical path.

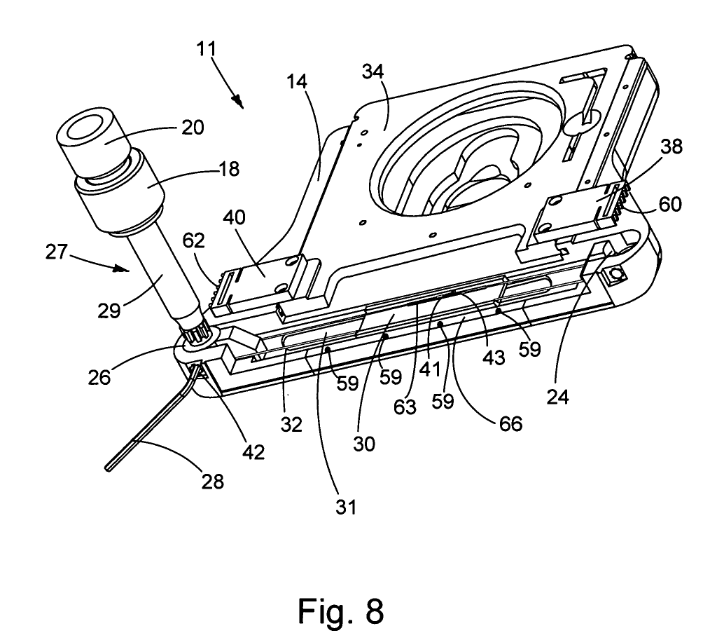

Drive 27 is detachably secured to stage 14 (FIG. 7). This attachment may be made in any number of ways readily apparent to those possessing ordinary skill in the art. In one preferred embodiment, the drive mechanism is detachably secured with a set screw 42 with the aid of wrench 28. Set screw 42 (FIGS. 7-8) engages stage 14 and retaining collar 44 of the drive 27. After removal of set screw 42 from the stage (FIG. 7), drive 27 may be removed and inserted into mounting hole 26 for left hand operation (FIG. 8) using set screw 42 and wrench 28.

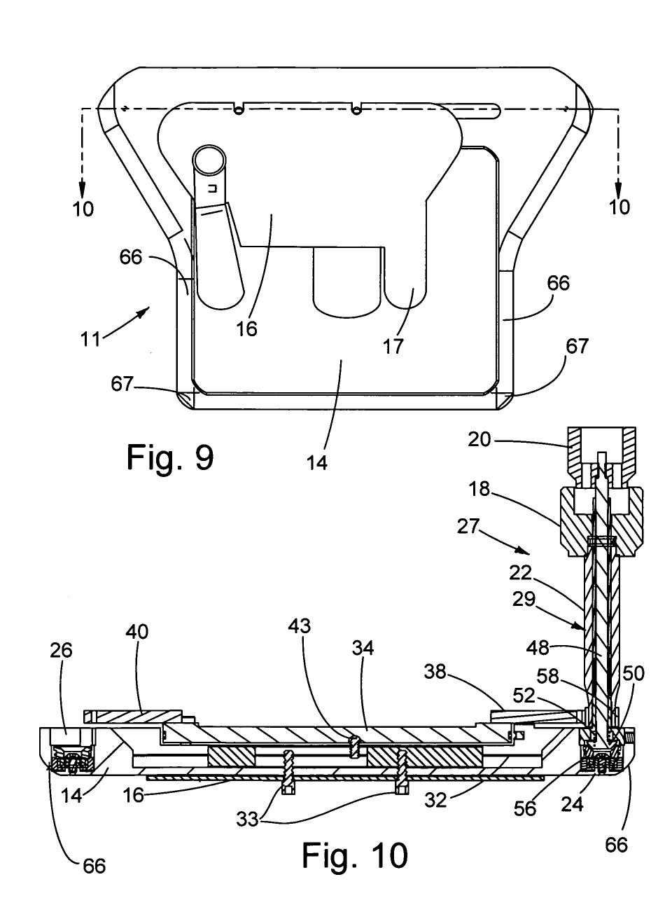

FIG. 9 is a plan view of the stage 14 of the present invention with slide mount 17 positioned off-center to illustrate the improved shielding achieved with virtually all components of the stage positioned at the bottom side of the stage through the slot in the stage floor.

FIG. 10 is a cross-sectional view of the microscope stage drive assembly of the present invention, taken generally along line 9-9 of FIG. 9. It can be seen in FIG. 10 that outer drive shaft 22 and inner drive shaft 48 are operatively arranged in a co-axial orientation. First stage positioning knob 18 is attached to outer drive shaft 22. Second stage positioning knob 20 is attached to inner drive shaft 48. The terminus of inner drive shaft 48, opposite second stage positioning knob 20, as depicted in this embodiment is a frustoconical plunger head 50, although other shapes of the plunger head are possible. Spring 52 is biased to provide an engagement force between plunger head 50 and drive pulley 56.

FIG. 10 is also a back-end, cross-sectional view of the stage and drive assembly showing of the present invention taken generally along line 10-10 of FIG. 9, depicting mainly the drive system for the slide mount 16 and the elements of the interchangeable microscope stage drive mechanism 27, all previously discussed.

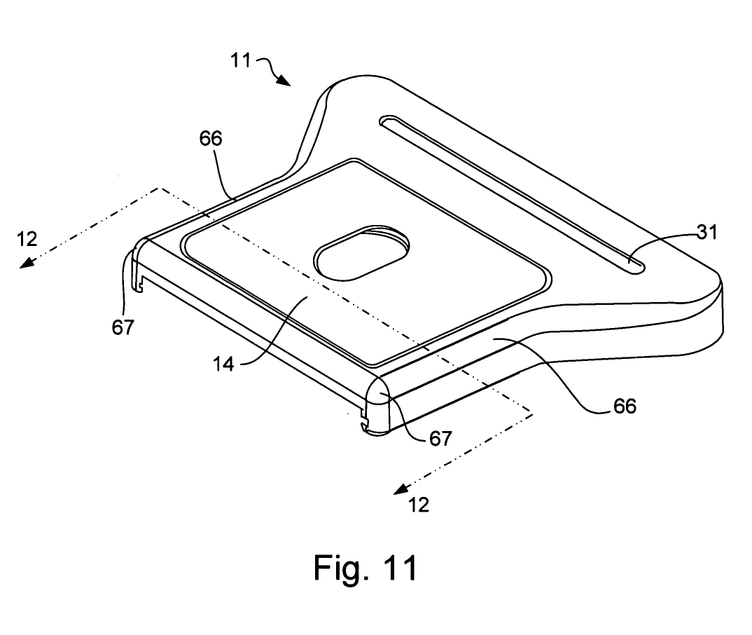

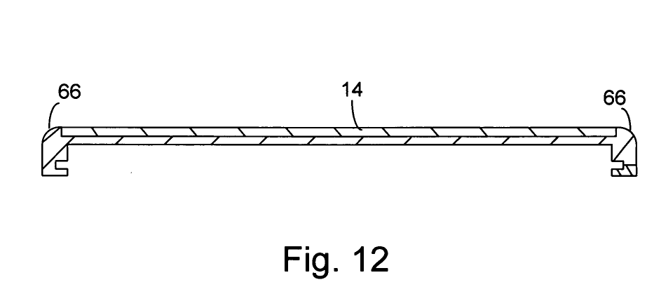

FIGS. 11 and 12 further illustrate the ergonomics of stage 14 with rounded rims at both stage edges 66 and at stage corners 67. While the upper edges and corners of the stage floor are shown as rounded, the invention contemplates embodiments wherein rounded rims extend to both the upper and lower edges of the stage. While this feature of the stage is illustrated with continuous rims that are rounded for maximum comfort for the user, a stage with rounded edges and corners may be applied to limited sections of the stage, wherein only portions of the stage have rounded corners and edges. The present invention thus contemplates rounded rims and corners which may be partial, and not run for the continuous length of the edges of the microscope stage, or run continuously, or in other words for the complete or substantially complete length of the edge and corners of the stage. The objective is to modify those portions the stage having relatively sharp pressure points the users hands would otherwise make contact with during the so-called “hand-drive” technique in adjusting the specimen slide, or upon placement of a specimen slide on the stage.

Thus, it is seen that the objects of the present invention are efficiently obtained, although modifications and changes to the invention should be readily apparent to those having ordinary skill in the art, which modifications are intended to be within the spirit and broad scope of the invention as claimed.

1. A microscope stage assembly, which comprises a stage having a top side and a bottom side, an opening in said stage in the form of a linear slot, a carriage positioned adjacent to said slot for movement in a direction generally parallel with said slot, drive means for said carriage and said stage, specimen retaining means on the top side of said stage, and means for affixing said specimen retaining means to said carriage through said opening in said stage.

2. The microscope stage assembly of claim 1, wherein said carriage and specimen retaining means move laterally relative to said stage in an x-axis.

3. The microscope stage assembly of claim 1 comprising a stage mounting plate for mounting said assembly to a microscope.

4. The microscope stage assembly of claim 3, including drive means for movement of said stage relative to said mounting plate in a y-axis.

5. The microscope stage assembly of claim 1, wherein said drive means for said carriage comprises a belt and pulley assembly, and a microscope stage drive mechanism for movement of said belt and pulley assembly.

6. The microscope stage assembly of claim 5, wherein said drive means for said carriage is positioned on the bottom side of said stage.

7. The microscope stage assembly of claim 1, wherein said drive means for said carriage comprises a drive mechanism suitable for detachably securing to said stage at more than one location.

8. The microscope stage assembly of claim 1 comprising a first engagement means for a microscope stage drive mechanism at a first location on said stage, and a second engagement means for said microscope stage drive mechanism at a second location on said stage.

9. The microscope stage assembly of claim 8, wherein said first location further comprises a microscope stage drive mechanism and a rack operatively arranged to engage with said microscope stage drive mechanism, for movement of said stage in a y-axis.

10. The microscope stage assembly of claim 9 comprising a stage mounting plate for mounting said assembly to a microscope, said rack mounted to said stage mounting plate, said microscope stage drive mechanism and said rack operatively arranged for movement of said stage relative to said mounting plate in a y-axis.

11. The microscope stage assembly of claim 8, wherein said second location further comprises a microscope stage drive mechanism and a rack operatively arranged to engage with said microscope stage drive mechanism.

12. The microscope stage assembly of claim 11 comprising a stage mounting plate for mounting said assembly to a microscope, said rack mounted to said stage mounting plate, said microscope stage drive mechanism and said rack operatively arranged for movement of said stage relative to said mounting plate in a y-axis.

13. The microscope stage assembly of claim 10 wherein said microscope stage drive mechanism is a unitary device adapted for movement of both said carriage and specimen retainer means relative to said stage in an x-axis, and movement of said stage relative to said stage mounting plate in a y-axis.

14. The microscope stage assembly of claim 11 wherein said microscope stage drive mechanism is a unitary device adapted for movement of both said carriage and specimen retainer means relative to said stage in an x-axis, and movement of said stage relative to said stage mounting plate in a y-axis.

15. The microscope stage assembly of claim 13 wherein said unitary microscope stage drive mechanism comprises an inner drive shaft and an outer drive shaft arranged coaxially with respect to said inner drive shaft.

16. The microscope stage assembly of claim 14 wherein said unitary microscope stage drive mechanism comprises an inner drive shaft and an outer drive shaft arranged coaxially with respect to said inner drive shaft.

17. The microscope stage assembly of claim 1, wherein the stage further comprises edges and/or corners which are rounded.

18. A microscope comprising the stage drive assembly of claim 1.

19. A microscope comprising the stage drive assembly of claim 2.

20. A microscope comprising the stage drive assembly of claim 3.

21. A microscope comprising the stage drive assembly of claim 4.

22. A microscope comprising the stage drive assembly of claim 5.

23. A microscope comprising the stage drive assembly of claim 7.

24. A microscope comprising the stage drive assembly of claim 9.

25. A microscope comprising the stage drive assembly of claim 12.

26. A microscope comprising the stage drive assembly of claim 17.

27. The microscope stage assembly of claim 1, wherein said stage includes a peripheral edge and at least a portion of said peripheral edge comprises an ergonometric rim.

28. The microscope stage assembly of claim 27, wherein said ergonometric rim is rounded.

29. The microscope stage assembly of claim 1, wherein said stage comprises at least one rounded corner.

30. The microscope stage assembly of claim 28, wherein said ergonometric rim further comprises a rounded corner.

31. A microscope comprising the microscope stage assembly of claim 27.

32. A microscope comprising the microscope stage assembly of claim 29.

33. A microscope stage comprising an ergonometric rim.

34. The microscope stage of claim 33, wherein said ergonometric rim comprises a rounded edge and a rounded corner.
